(19) United States
(12) Patent Application Publication
(10) Pub. No.: US 2018/0024677 A1
(43) Pub. Date: Jan. 25, 2018

(54) TOUCH DISPLAY DRIVING INTEGRATED CIRCUIT AND OPERATION METHOD THEREOF

(71) Applicant: SAMSUNG ELECTRONICS CO., LTD., Suwon-si (KR)

(72) Inventors: Minsung KIM, Seoul (KR); Jaehun JEONG, Hwaseong-si (KR); Haewoon PARK, Yangpyeong-gun (KR); Seung-Hoon BAEK, Seongnam-si (KR); San-ho BYUN, Bucheon-si (KR); Jinbong KIM, Yongin-si (KR); YoonKyung CHOI, Seoul (KR)

(73) Assignee: SAMSUNG ELECTRONICS CO., LTD., Suwon-si (KR)

(21) Appl. No.: 15/637,635

(22) Filed: Jun. 29, 2017

(30) Foreign Application Priority Data
Jul. 20, 2016 (KR) 10-2016-0092130

(51) Int. Cl. G06F 3/041; G09G 3/3275; G09G 3/3266; G06F 3/044; G09G 3/3233

(52) U.S. Cl. CPC G06F 3/0412; G06F 3/044; G09G 3/3233; G09G 3/3266; G09G 3/3275; G09G 2300/0809; G09G 2310/0264; G09G 2320/029

(57) ABSTRACT

An operating method of a touch display driving integrated circuit that is connected with a touch display panel through touch sensing lines and data lines is provided. The method includes applying a common voltage to each touch sensing line, increasing voltages of the touch sensing lines and the data lines by a predetermined level, providing a first touch sensing signal to each touch sensing line, and sensing a touch of a user based on signal variations of the touch sensing lines.

### CROSS-REFERENCE TO RELATED APPLICATIONS

This application claims priority under 35 U.S.C. §119 to Korean Patent Application No. 10-2016-0092130 filed Jul. 20, 2016, in the Korean Intellectual Property Office, the entire contents of which are hereby incorporated by reference.

### BACKGROUND

Exemplary embodiments consistent with the inventive concept relate to a display device, and more particularly, to a touch display driving integrated circuit (IC) and an operating method thereof.

A display device includes gate lines, data lines, and a plurality of pixels. The pixels are connected to the gate lines and the data lines, respectively. The display device includes a gate driving circuit controlling the gate lines and a data driving circuit controlling the data lines. The gate driving circuit provides a gate signal to each gate line, the data driving circuit provides a data signal to each data line, and each pixel displays image information based on the signals received through the data lines and the gate lines.

As a user terminal is miniaturized, an in-cell type touch display device in which a display device and a touch panel are integrated is being developed. In the in-cell type touch display device, an area that is occupied by the touch panel and a panel of the display device may be reduced by integrating the touch panel and the display panel of the display device. However, various issues occur due to driving methods as the touch panel and the display panel are integrated. Various driving methods for addressing these issues are being developed.

### SUMMARY

It is an aspect to provide a touch display driving IC with improved performance and reliability and an operating method thereof.

According to an aspect of an exemplary embodiment, there is provided an operating method of a touch display driving integrated circuit that is connected with a touch display panel through touch sensing lines and data lines. The method includes applying a common voltage to each touch sensing line, increasing voltages of the touch sensing lines and the data lines by a predetermined level, providing a first touch sensing signal to each touch sensing line, and sensing a touch of a user based on signal variations of the touch sensing lines.

According to another aspect of an exemplary embodiment, a touch display driving integrated circuit includes a touch driver connected to touch electrodes and touch sensing lines to provide a common voltage to each touch sensing line during a display period and to provide a first touch sensing signal to each touch sensing line during a touch period, a transition voltage controller configured to output a first output voltage during the display period and to output a second output voltage higher than by a predetermined level than the first output voltage during a transition period from the display period to the touch period, and a source driver connected with pixels through data lines to provide a data signal to each data line during the display period and to provide the second output voltage to each data line during the transition period.

According to another aspect of an exemplary embodiment, a touch display device includes a touch display panel including a touch electrode and a pixel, and a touch display driving integrated circuit configured to control the touch display panel. The touch display driving integrated circuit includes a touch driver connected with the touch electrode through a touch sensing line to apply a common voltage to the touch sensing line during a display period and to provide a first touch sensing signal to the touch sensing line during a touch period, a transition voltage controller configured to output a first output voltage in the display period and to output a second output voltage higher than by a predetermined level than the first output voltage during a transition period from the display period to the touch period, and a source driver connected with the pixel through a data line to provide a data signal to the data line during the display period and to provide the second output voltage to the data line during the transition period.

According to another aspect of an exemplary embodiment, a touch display device comprises a touch display panel including a plurality of touch electrodes and a plurality of pixels, each touch electrode provided as a common electrode for one or more pixels of the plurality of pixels; and a touch display driving integrated circuit (TDDIC) connected to each touch sensing electrode by a touch sensing line, and connected to each pixel by a data line and a gate line, wherein the TDDIC is configured to apply a common voltage to the touch electrodes during a display period to perform a display operation during the display period, increase voltages of one ore more of the touch sensing lines, one or more of the data lines, and one or more of the gate lines by a predetermined level during a first transition period, detect a touch via the touch sensing lines, the data lines, and the gate lines during a touch period, and decrease the voltages of the one or more touch sensing lines, the one or more of the data lines, and the one or more of the gate lines by the predetermined level during a second transition period.

### BRIEF DESCRIPTION OF THE FIGURES

The above and other aspects will become apparent from the following description with reference to the following figures, wherein like reference numerals refer to like parts throughout the various figures unless otherwise specified, and wherein:

FIG. 1 is a block diagram illustrating a touch display device according to an exemplary embodiment of the inventive concept;

FIG. 2 is a drawing for describing a configuration of a touch electrode and pixels of the touch display device of FIG. 1;

FIG. 3 is a drawing for describing an operation of the touch display device in display and touch periods;

FIG. 4 is a flowchart illustrating an operation of a touch display driving integrated circuit (TDDIC) of the touch display device of FIG. 1, according to an exemplary embodiment;

FIG. 5 is a graph for describing an operating method of FIG. 4;

FIG. 6 is a block diagram illustrating a TDDIC of the touch display device of FIG. 1 in more detail;

FIG. 7 is a circuit diagram illustrating a transition voltage controller of the TDDIC of FIG. 6, according to an exemplary embodiment;

FIG. 8 is a timing diagram illustrating an operation of the transition voltage controller of FIG. 7;

FIG. 9 is a circuit diagram illustrating switching operations of the transition voltage controller according to the timing diagram of FIG. 8;

FIG. 10 is a block diagram illustrating another example of the TDDIC for implementing an operation described with reference to FIGS. 4 and 5;

FIG. 11 is a block diagram illustrating another example of the TDDIC for implementing an operation described with reference to FIGS. 4 and 5;

FIG. 12 is an exemplary block diagram of a transition voltage controller using an external capacitor;

FIG. 13 is a drawing illustrating an arrangement of a plurality of touch electrodes included in the touch display panel of FIG. 1;

FIG. 14 is a block diagram illustrating an integrated circuit, according to an exemplary embodiment of the inventive concept; and

FIGS. 15A and 15B are drawings illustrating timing between a touch driver block and a display driver block of the integrated circuit of FIG. 14.

### DETAILED DESCRIPTION

Below, exemplary embodiments of the inventive concept are described in detail and clearly to such an extent that one of ordinary skill in the art may easily implement the inventive concept.

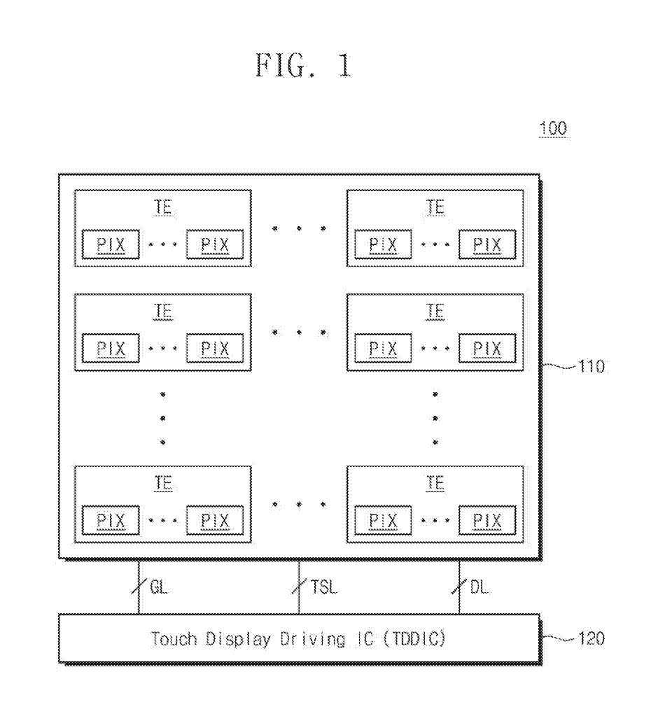

FIG. 1 is a block diagram illustrating a touch display device according to an exemplary embodiment of the inventive concept. Referring to FIG. 1, a touch display device 100 may include a touch display panel 110 and a touch display driving integrated circuit (TDDIC) 120. In example embodiments, the touch display device 100 may be a touch display device with a touch function. For example, the touch display device 100 may be an in-cell or on-cell type touch display device. For ease of description, a term or a phrase of “a touch of a user” is used herein, but this inventive concept is not limited thereto. The term or the phrase of “a touch of a user” may be intended to comprise single touch or multi-touches.

The touch display panel 110 may include a plurality of pixels PIX and a plurality of touch electrodes TE. The pixels PIX may be connected with gate lines GL and data lines DL, respectively. The pixels PIX may display image information based on voltages of the gate lines GL and data lines DL. In example embodiments, the pixels PIX may be classified into a plurality of groups based on colors to be displayed. Each pixel PIX may display one of the primary colors. The primary colors may include, but are not limited to, red, green, blue, and white. For example, the primary colors may further include various colors such as yellow, cyan, and magenta.

The touch electrodes TE may be used as common electrodes of the pixels PIX, or as electrodes for sensing a touch of a user. For example, the touch display panel 110 may be an in-cell type touch display panel. The in-cell type touch display panel may be implemented such that the pixels PIX and the touch electrodes TE are arranged on the same panel.

The touch electrodes TE may be used as a common electrode of the pixels PIX. For example, each of the pixels PIX may output image information based on a difference between a data signal received through the data line DL and a common voltage VCOM. Each of the pixels PIX may compare a data signal received through the data line DL with the common voltage VCOM of the touch electrode TE and may output image information based on the comparison result.

In example embodiments, an area of one touch electrode TE may be larger than that of one pixel PIX. One touch electrode TE may be used as the common electrode of one or more pixels PIX. In other words, one touch electrode TE may correspond to one or more pixels PIX. In example embodiments, the common voltage VCOM may be a negative voltage of about −1.3 V. In example embodiments, the touch electrode TE may be a transparent conductive layer such as indium tin oxide (ITO).

Although not illustrated in FIG. 1, the touch display panel 110 may include, but is not limited to, various display panels such as a liquid crystal display panel, an organic light emitting display panel, an electrophoretic display panel, and an electrowetting display panel. For example, the touch display panel 110 according to an example embodiment of the inventive concept may be implemented with the above-described display panels or other display panels. In example embodiments, the touch display device 100 including the liquid crystal display panel may further include a polarizer (not illustrated), a backlight unit (not illustrated), etc.

The TDDIC 120 may be connected with the touch display panel 110 through the gate lines GL, the data lines DL, and touch sensing lines TSL.

For example, the TDDIC 120 may be connected with the pixels PIX included in the touch display panel 110 through the gate lines GL. The TDDIC 120 may control voltages of the gate lines GL connected with the pixels PIX or may provide gate signals through the gate lines GL.

The TDDIC 120 may be connected with the pixels PIX through the data lines DL. The TDDIC 120 may provide data signals (or image signals) to the pixels PIX through the data lines DL. Each pixel PIX may output (or display) image information in response to the received data signal.

The TDDIC 120 may be connected with the touch electrodes TE through the touch sensing lines TSL. The TDDIC 120 may provide a touch sensing signal to each touch sensing line TSL and may sense whether a touch of the user is made, based on a variation of the touch sensing signal. For example, in the case where the user brings a portion (e.g., a finger) of his/her body into contact with at least one touch electrode TE of the touch electrodes TE, capacitance of the at least one touch electrode TE may change according to capacitance between the portion of his/her body and the at least one touch electrode TE. The TDDIC 120 may sense a variation in the capacitance based on a variation of the touch sensing signal provided to the at least one touch electrode TE.

The TDDIC 120 is capable of determining that a user touch has occurred at a touch electrode TE from which a variation in capacitance is sensed. In example embodiments, the above-described touch sensing method is called a “self-capacitance method” or “mutual capacitance method”. However, example embodiments are not limited thereto. For example, the touch sensing method may be variously changed or modified without departing from the scope and spirit of the inventive concept.

In example embodiments, the TDDIC 120 may operate in synchronization with control signals received from a separate control circuit (not illustrated) (e.g., a timing controller). For example, the control signals may include a vertical synchronization signal and a horizontal synchronization signal. The vertical synchronization signal may be a signal for distinguishing frames to be output through the pixels PIX. The horizontal synchronization signal may be a signal for distinguishing a row corresponding to data signals provided through the data lines DL, that is, a row distinguishing signal. In response to the control signals, the TDDIC 120 may control a voltage of the gate line connected with a pixel PIX and may provide a data signal through the data line DL connected with the pixel PIX.

The touch display device 100 may include at least one display period and at least one touch period during an output of one frame (i.e., during one period of the vertical synchronization signal). The touch display device 100 may display all or part of one frame during at least one display period and may perform a touch scan operation on all or some of the touch electrodes TE during at least one touch period.

To perform the touch scan operation on touch electrodes TE during at least one touch period, a predetermined signal (e.g., a touch sensing signal) may be provided to each touch electrode TE. Since the touch electrode TE is used as a common electrode during at least one display period, the common voltage VCOM may be applied to all or part of the touch electrodes during at least one display period. As the touch display device 100 repeatedly performs the above-described display and touch periods, the touch display device 100 may display image information and may sense a touch of the user.

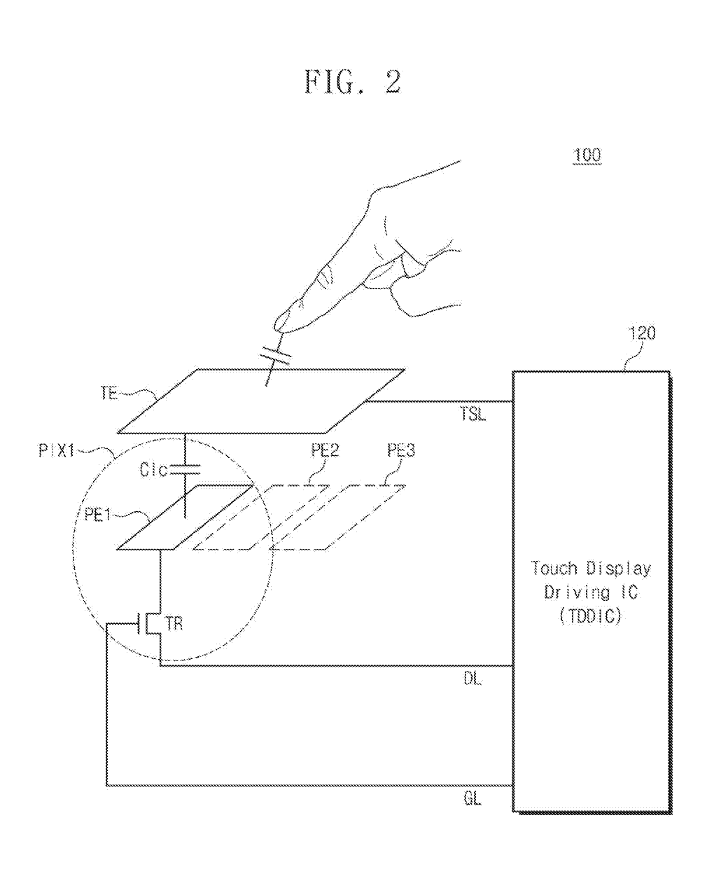

FIG. 2 is a drawing for describing a configuration of a touch electrode and pixels of a touch display device of FIG. 1. For ease of illustration and for convenience of description, the connection of a pixel PIX, a touch electrode TE, and the TDDIC 120 will be described with reference to some components. However, example embodiments are not limited thereto. For example, the touch display panel 110 may further include other components such as a color filter and a level shifter, etc.

Referring to FIGS. 1 and 2, a first pixel PIX1 may include a first pixel electrode PE1 and a transistor TR. In example embodiments, the transistor TR may be a thin film transistor (TFT). A source of the transistor TR is connected with the TDDIC 120 through the data line DL, a drain thereof is connected with the first pixel electrode PE1, and a gate thereof is connected with the TDDIC 120 through the gate line GL.

In example embodiments, a liquid crystal layer (not illustrated) may be arranged between the first pixel electrode PE1 and the touch electrode TE. In such a case, a liquid crystal capacitor Clc may exist between the first pixel electrode PE1 and the touch electrode TE. The common voltage VCOM may be applied to the touch electrode TE. Under control of the TDDIC 120, an electric field may be formed by a voltage received through the data line DL and the common voltage VCOM of the touch electrode TE. The arrangement of liquid crystal directors of the liquid crystal layer (not illustrated) may change according to the electric field that is formed by the voltage of the data line DL and the common voltage VCOM. On the basis of the arrangement of the liquid crystal directors, light incident on the liquid crystal layer may pass through the liquid crystal layer or may be blocked. Image information may be displayed based on the above-described operation of the first pixel PIX1.

During a touch period of the touch display device 110, the TDDIC 120 may drive the touch sensing line TSL connected with the touch electrode TE. For example, the TDDIC 120 may provide the touch sensing signal to the touch sensing line TSL. In the case where a portion of a user's body touches the touch electrode TE or approaches the touch electrode TE, a signal of the touch sensing line TSL may change by capacitance between the touch electrode TE and the portion of the user's body. The TDDIC 120 may sense a signal variation (or change) of the touch sensing line TSL and may recognize that the user touches the touch electrode TE, based on the sensing result.

In example embodiments, as illustrated in FIG. 2, one touch electrode TE may be arranged on or over a plurality of pixel electrodes PE. For example, as described with reference to FIG. 1, the touch electrode TE may be used as a common electrode during the display period. That is, during the display period, image information may be displayed by a voltage difference between the touch electrode TE used as the common electrode and the pixel electrodes PE1, PE2, and PE3. The arrangement and configuration of the pixel electrodes PE1, PE2, and PE3 and the touch electrode TE illustrated in are exemplary, and example embodiments of the inventive concept may not be limited thereto. For example, one or more touch electrodes may be arranged on or over a plurality of pixel electrodes to be arranged in various manners.

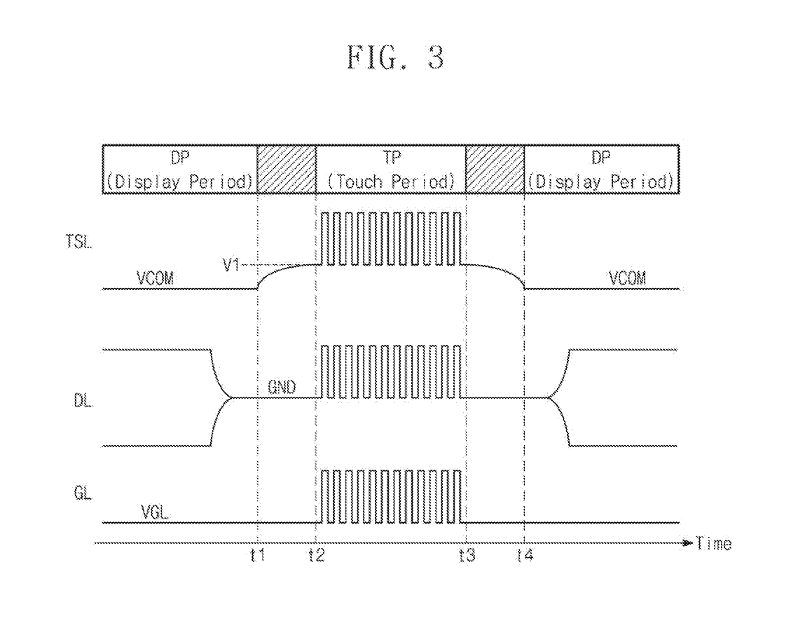

FIG. 3 is a drawing for describing an operation of a touch display device in display and touch periods. For a brief description, components which are unnecessary to describe operations of the display and touch periods are omitted. Referring to FIGS. 1 and 3, during the display period DP, the TDDIC 120 may apply the common voltage VCOM to each touch sensing line TSL, may provide a data signal to each data line DL, and may apply a gate voltage VGL to each gate line GL. In example embodiments, the gate voltage VGL may be a voltage for providing a gate signal to each gate line GL. In example embodiments, the gate voltage VGL may be a turn-off voltage of a transistor (e.g., a thin film transistor) included in a pixel PIX. In example embodiments, a VGL-based gate signal may be provided to the gate lines GL.

In example embodiments, a gate signal may be a signal that is synchronized with a control signal (e.g., a vertical synchronization signal). In example embodiments, a gate signal may be a signal that is toggled between the gate voltage VGL and a gate voltage VGH (not illustrated). In example embodiments, the gate voltage VGH may be a turn-on voltage of a transistor included in a pixel PIX.

During the display period DP, the touch display device 100 may display image information in response to signals from the TDDIC 120. After the display period DP ends, the touch period TP may start. For example, after the TDDIC 120 provides a touch sensing signal to each of the touch sensing lines TSL, the data lines DL, and the gate lines GL, the TDDIC 120 may sense signal variations of the touch sensing lines TSL to determine whether a touch of the user is made. In example embodiments, the touch sensing signal may be a signal that is toggled between specific levels.

In example embodiments, during the touch period TP, the TDDIC 120 may perform the touch scan operation at a voltage level greater than or equal to that of a first voltage V1. For example, from a first time point t1 at which the display period DP ends to a second time point t2 at which the touch period TP starts, the TDDIC 120 may increase a voltage of each touch sensing line TSL from the common voltage VCOM to the first voltage V1. In example embodiments, the common voltage VCOM may be a negative voltage of about −1.3 V. The first voltage V1 may be a ground voltage GND. That is, the TDDIC 120 may perform the touch scan operation at a positive voltage level. Likewise, after the touch period TP ends, the TDDIC 120 may lower a voltage of each touch sensing line TSL from the first voltage V1 to the common voltage VCOM.

As described above, in a period (e.g., from t1 to t2) from the display period DP to the touch period TP, a voltage of each touch sensing line TSL may be changed from the common voltage VCOM to the first voltage V1. Also, in a period (e.g., from t3 to t4) from the touch period TP to the display period DP, a voltage of each touch sensing line TSL may be changed from the first voltage V1 to the common voltage VCOM.

Below, for convenience of description, a period from the display period DP to the touch period TP, and a period from the touch period TP to the display period DP is referred to as a “transition period”. However, the term “transition period” is only used is to easily describe example embodiments of the inventive concept, and a period corresponding to the transition period may be viewed as being included in the display period DP or the touch period TP.

In example embodiments, as illustrated in FIG. 3, voltages of the data lines DL and the gate lines GL may be maintained uniformly in the transition period. In this case, when a voltage of a touch sensing line TSL changes, a settling speed at which the touch sensing line TSL is increased to the first voltage or decreased to the common voltage VCOM may decrease due to various parasitic capacitances in the touch display panel 110.

For example, as described with reference to FIG. 2, unintended parasitic capacitance may exist among the touch electrodes TE, the pixel electrodes PE, the touch sensing lines TSL, the data lines DL, and the gate lines GL included in the touch display panel 110. In the transition period, such parasitic capacitance may cause a decrease in a speed, at which a touch sensing line TSL is increased to the first voltage or decreased to the common voltage VCOM, and that may cause an increase in the transition period. In addition, the increase in the transition period may cause a decrease of performance of the touch display panel 110 or a poor image display.

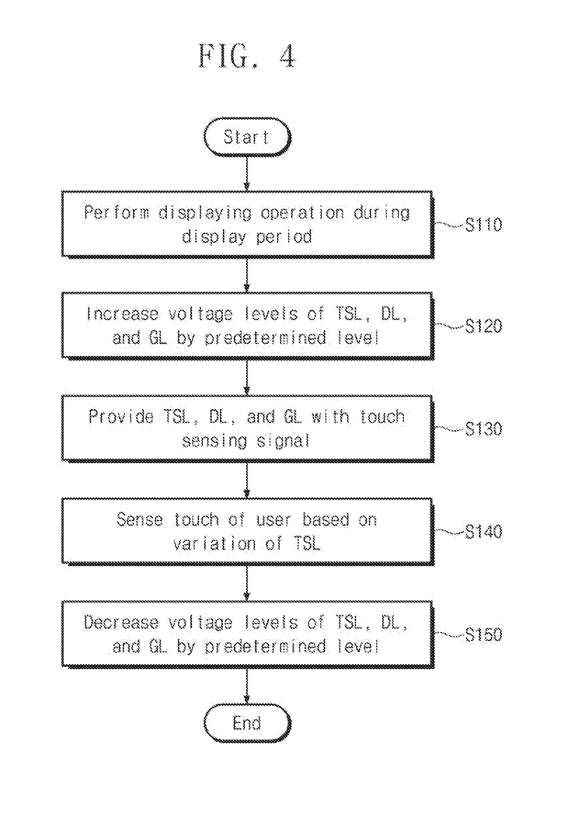

FIG. 4 is a flowchart illustrating an operation of a TDDIC of the touch display device of FIG. 1, according to an example embodiment of the inventive concept. Referring to FIGS. 1, 3, and 4, in an operation S110, the TDDIC 120 performs a displaying operation during a display period. For example, as described above, the TDDIC 120 may provide the common voltage VCOM to each touch sensing line TSL, a gate signal (or gate voltage) to each gate line GL, and a data signal to each data line DL. The touch display panel 110 may display image data based on the received signals. In example embodiments, image information about all or part of one frame may be displayed during one display period.

In an operation S120, the TDDIC 120 may increase voltages of the touch sensing lines TSL, the data lines DL, and the gate lines GL by a predetermined level. For example, after the display period ends, a voltage level of each touch sensing line TSL may correspond to the common voltage VCOM. For a touch sensing operation in the touch period, the TDDIC 120 may increase a voltage of each touch sensing line TSL to the first voltage V1. In example embodiments, the first voltage V1 may be a ground voltage GND, but is not limited thereto.

After the display period ends, a voltage level of each data line DL may be a level of the ground voltage GND, and a voltage level of each gate line GL may be a level of the gate voltage VGL. While the TDDIC 120 increases a voltage of each touch sensing line TSL to the first voltage V1 (in other words, a switching period from the display period to the touch period, that is, the transition period), the TDDIC 120 may increase a voltage of each data line DL to a second voltage V2 and a voltage of each gate line GL to a third voltage V3. In this case, a difference between the second voltage V2 and the ground voltage GND and a difference between the third voltage V3 and the gate voltage VGL may be substantially the same as a difference between the first voltage V1 and the common voltage VCOM. That is, the TDDIC 120 may increase voltages of the touch sensing lines TSL, the data lines DL, and the gate lines GL by a predetermined level.

That is, as described above, during the transition period, an influence (e.g., a voltage coupling) of the above-described parasitic capacitances may be removed as the TDDIC 120 increases voltages of the touch sensing lines TSL, the data lines DL, and the gate lines GL by a predetermined level together with each other. That is, as an operation of the operation S120 is performed, a time needed to settle the touch sensing lines TSL to the first voltage V1 may decrease, and the transition period may become shorter than that described with reference to FIG. 3.

In an operation S130, the TDDIC 120 may provide the touch sensing signals to the touch sensing lines TSL, the data lines DL, and the gate lines GL. In example embodiments, the touch sensing signals provided to the touch sensing lines TSL, the data lines DL, and the gate lines GL may have the same waveform, but the touch sensing signals may have different voltage levels. For example, a voltage level of a first touch sensing signal provided to each touch sensing line TSL may be lower than that of a second touch sensing signal provided to each data line DL and may be higher than that of a third touch sensing signal provided to each gate line GL.

In an operation S140, the TDDIC 120 may sense a touch of the user based on signal variations (or changes) of the touch sensing lines TSL.

After the touch period ends, in an operation S150, the TDDIC 120 may decrease voltages of the touch sensing lines TSL, the data lines DL, and the gate lines GL by a predetermined level. For example, after the touch period ends, a voltage level of each touch sensing line TSL may correspond to a level of the first voltage V1. For a display operation in the display period, the TDDIC 120 may decrease voltage levels of the touch sensing lines TSL to the common voltage VCOM.

After the touch period ends, a voltage level of each data line DL may correspond to a level of the second voltage V2, and a voltage level of each gate line GL may correspond to a level of the third voltage V3. While the TDDIC 120 decreases a voltage of each touch sensing line TSL to the common voltage VCOM (in other words, a switching period from the touch period to the display period, that is, the transition period), the TDDIC 120 may decrease voltages of the data lines DL and voltages of the gate lines GL by a predetermined level. In this case, the predetermined level may correspond to a difference between the common voltage VCOM and the first voltage V1.

That is, as described above, during the transition periods, an influence (e.g., a voltage coupling) of the above-described parasitic capacitances may be removed as the TDDIC 120 decreases voltages of the touch sensing lines TSL, the data lines DL, and the gate lines GL by a predetermined level together with each other. In other words, as an operation of the operation S150 is performed, the transition period may become shorter than that described with reference to FIG. 3.

In example embodiment, as the TDDIC 120 repeatedly performs operations of the operation S110 to the operation S150, the TDDIC 120 may display image information and may sense a touch of the user.

As described above, as the TDDIC 120 according to an exemplary embodiment of the inventive concept controls voltages of the touch sensing lines TSL, the data lines DL, and the gate lines GL together with each other, the settling speed at which the touch sensing line TSL is increased to the first voltage or decreased to the common voltage VCOM may be improved. Accordingly, the TDDIC 120 with improved performance is provided.

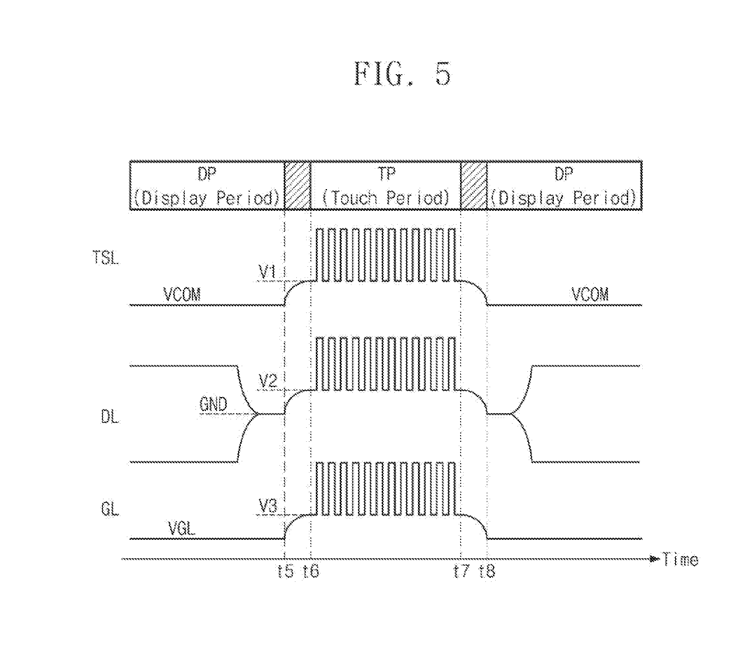

FIG. 5 is a graph for describing an operating method of FIG. 4. For convenience of description, a detailed description of the above-described components is omitted. Referring to FIGS. 1, 4, and 5, during the display period DP, the TDDIC 120 may apply the common voltage VCOM to each touch sensing line TSL, may provide a data signal to each data line DL, and may provide a gate voltage VGL to each gate line GL.

After the display period ends, in the transition period, the TDDIC 120 may increase voltages of the touch sensing lines TSL, the data lines DL, and the gate lines GL by a predetermined level. For example, in the transition period from t5 to t6, the TDDIC 120 may increase a voltage of each touch sensing lines TSL to the first voltage V1, may increase a voltage of each data line DL to the second voltage V2, and may increase a voltage of each gate line GL to the third voltage V3.

The first voltage V1 may be a voltage that is higher by a predetermined level than the common voltage VCOM. In example embodiment, the first voltage V1 may be the ground voltage GND. The second voltage V2 may be a voltage that is higher by a predetermined level than the ground voltage GND. The third voltage V3 may be a voltage that is higher by a predetermined level than the gate voltage VGL.

As described above, as the TDDIC 120 increases voltages of the touch sensing lines TSL, the data lines DL, and the gate lines GL together with each other by a predetermined level during the transition period, a voltage of each touch sensing line TSL may be quickly settled to the first voltage V1, thereby making a start time point of the following touch period TP earlier.

During the touch period TP, after the TDDIC 120 provides touch sensing signals to the touch sensing lines TSL, the data lines DL, and the gate lines GL, the TDDIC 120 may determine whether a touch of the user is made, based on signal variations of the touch sensing lines TSL.

After the touch period TP ends, the TDDIC 120 may decrease voltages of the touch sensing lines TSL, the data lines DL, and the gate lines GL by a predetermined level. For example, in the transition period from t7 to t8, the TDDIC 120 may decrease a voltage of each touch sensing line TSL to the common voltage VCOM, may decrease a voltage of each data line DL to the ground terminal GND, and may decrease a voltage of each gate line GL to the gate voltage VGL. As the TDDIC 120 decreases voltages of the touch sensing lines TSL, the data lines DL, and the gate lines GL together with each other by a predetermined level during the transition period, voltages thereof may be quickly settled to target voltages, thereby making a start time point of the display period earlier.

As described above, as the TDDIC 120 according to an embodiment of the inventive concept controls voltages of the touch sensing lines TSL, the data lines DL, and the gate lines GL together with each other during the transition period, the transition period may be reduced. Accordingly, the TDDIC 120 with improved performance is provided.

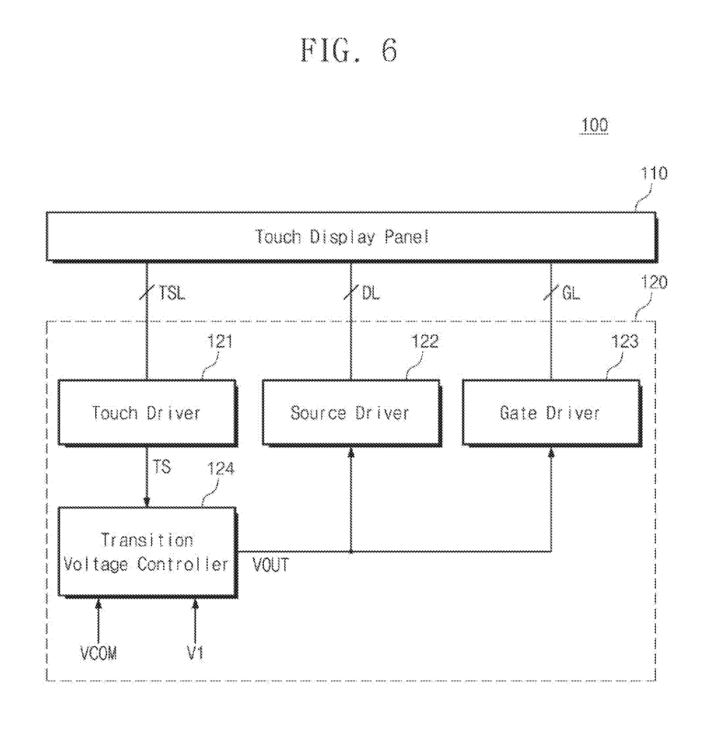

FIG. 6 is a block diagram illustrating a TDDIC of the touch display panel of FIG. 1 in more detail. In example embodiments, a configuration of the TDDIC 120 illustrated in FIG. 6 is an example for implementing the operating method described with reference to FIGS. 4 and 5, but example embodiments of the inventive concept are not limited thereto.

Referring to FIGS. 1 and 4 to 6, the touch display device 100 may include a touch display panel 110 and the TDDIC 120. The TDDIC 120 may include a touch driver 121, a source driver 122, a gate driver 123, and a transition voltage controller 124.

The touch driver 121 may be connected with the touch display panel 110. In more detail, the touch driver 121 may be connected with the plurality of touch electrodes TE of the touch display panel 110 through the touch sensing lines TSL. The touch driver 121 may provide the common voltage VCOM to each touch sensing line TSL during the display period DP and may provide a touch sensing signal to each touch sensing line TSL during the touch period TP. During the touch period TP, the touch driver 120 may sense a touch of the user based on signal variations of the touch sensing lines TSL.

The source driver 122 may be connected with the touch display panel 110. In more detail, the source driver 122 may be connected with the plurality of pixels PIX of the touch display panel 110 through the data lines DL. During the display period DP, the source driver 122 may provide data signals to the pixels PXI through the data lines DL in response to a separate control signal.

The gate driver 123 may be connected with the touch display panel 110. In more detail, the gate driver 123 may be connected with the plurality of pixels PIX of the touch display panel 110 through the gate lines GL. During the display period DP, the gate driver 123 may provide gate signals through the gate lines GL in response to a separate control signal.

The transition voltage controller 124 may control voltages to be provided to the source driver 122 and the gate driver 123 in the transition period from the display period DP to the touch period TP. For example, on the basis of an output voltage VOUT from the transition voltage controller 124, the source driver 122 and the gate driver 123 may respectively provide the touch sensing signals to the data lines DL and the gate lines DL during the touch period TP.

The transition voltage controller 124 may receive a touch sensing signal TS from the touch driver 121 and may receive the common voltage VCOM and the first voltage V1 from a voltage generator (not illustrated). In the transition period from the display period DP to the touch period TP, the transition voltage controller 124 may control the output voltage VOUT such that voltages of the data lines DL and voltages of the gate lines GL are increased by a predetermined level.

For example, as described with reference to FIGS. 4 and 5, at a time point (i.e., t5) at which the display period DP ends, a voltage of each data line DL may correspond to the ground voltage GND, and a voltage of each gate line GL may correspond to the gate voltage VGL. The transition voltage controller 124 may control the output voltage VOUT such that a voltage of each data line DL increases to the second voltage V2 and a voltage of each gate line GL increases to the third voltage V3. The source driver 122 may increase a voltage of each data line DL to the second voltage V2 based on the output voltage VOUT, and the gate driver 123 may increase a voltage of each gate line GL to the third voltage V3 based on the output voltage VOUT.

At a time point at which the touch period TP starts after the transition period ends, the transition voltage controller 124 may provide the touch sensing signal TS from the touch driver 121 as the output voltage VOUT. The source driver 122 may provide the touch sensing signal TS to each data line DL based on the output voltage VOUT, and the gate driver 123 may provide the touch sensing signal TS to each gate line GL based on the output voltage VOUT.

As described above, in the transition period, the transition voltage controller 124 may control the output voltage VOUT to be provided to the source driver 122 and the gate driver 123 such that voltages of the data lines DL and the gate lines GL are increased by a predetermined level. Afterwards, the transition voltage controller 124 may provide the touch sensing signal TS as the output voltage VOUT. The source driver 122 may control the data lines DL based on the output voltage VOUT, and the gate driver 123 may control the gate lines GL based on the output voltage VOUT.

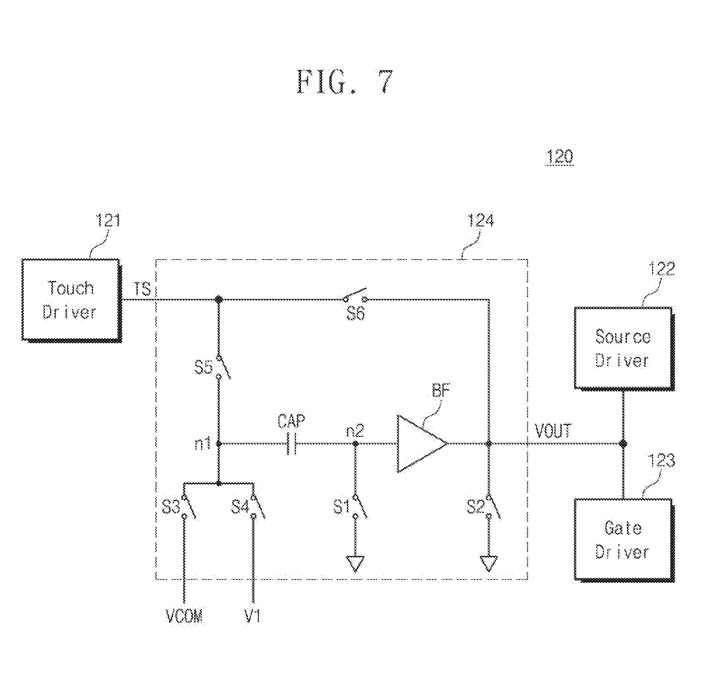

FIG. 7 is a circuit diagram illustrating an exemplary embodiment of a transition voltage controller of FIG. 6 in detail. In example embodiments, a configuration of the transition voltage controller 124 illustrated in FIG. 7 is exemplary, and example embodiments of the inventive concept are not limited thereto. The transition voltage controller 124 may be variously changed or modified to control voltages of the data lines DL and the gate lines GL during the transition period.

Referring to FIGS. 6 and 7, the TDDIC 120 may include the touch driver 121, the source driver 122, the gate driver 123, and the transition voltage controller 124. Since the touch driver 121, the source driver 122, and the gate driver 123 are described with reference to FIG. 6, a detailed description thereof is omitted.

The transition voltage controller 124 includes first to sixth switches S1 to S6, a capacitor CAP, and a buffer BF. The first switch S1 is configured to connect a second node n2 and a ground terminal. The second switch S2 is configured to connect a terminal of the output voltage VOUT and the ground terminal. The third switch S3 is configured to connect a terminal of the common voltage VCOM and a first node n1. The fourth switch S4 is configured to connect a terminal of the first voltage V1 and the first node n1. The fifth switch S5 is configured to connect a terminal, to which the touch sensing signal TS from the touch driver 121 is applied, and the first node n1. The sixth switch S6 is configured to connect the terminal, to which the touch sensing signal TS from the touch driver 121 is applied, and the terminal of the output voltage VOUT.

The capacitor CAP is connected between the first node n1 and the second node n2. The buffer BF is connected between the second node n2 and the terminal of the output voltage VOUT and is configured to buffer a voltage of the second node n2 and to provide the buffered voltage as the output voltage VOUT. In example embodiments, the capacitor CAP may be an external capacitor that is placed outside of the TDDIC 120. Alternatively, the capacitor CAP may be implemented with some of capacitors that are used in a separate voltage generator.

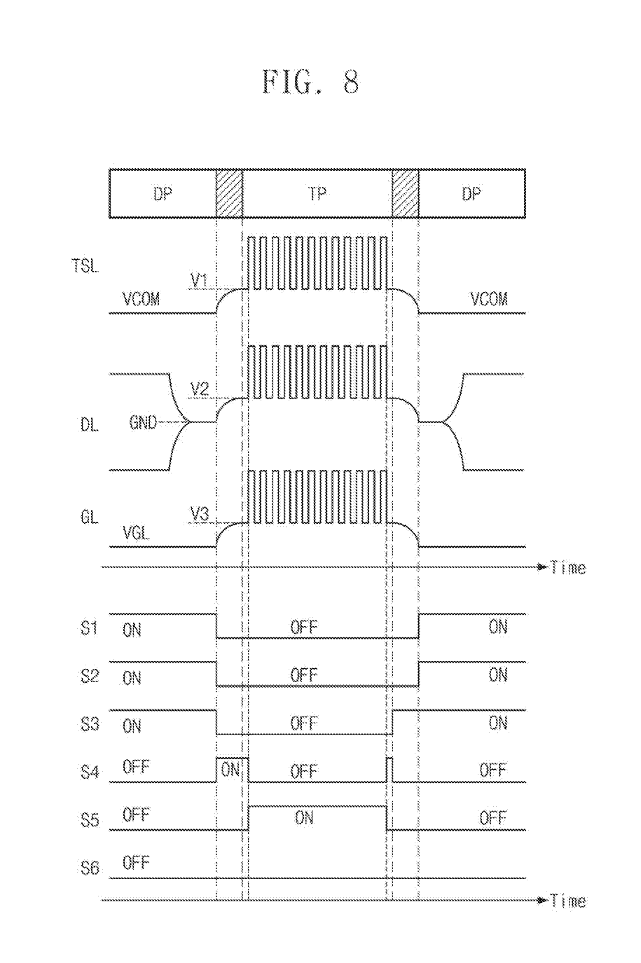

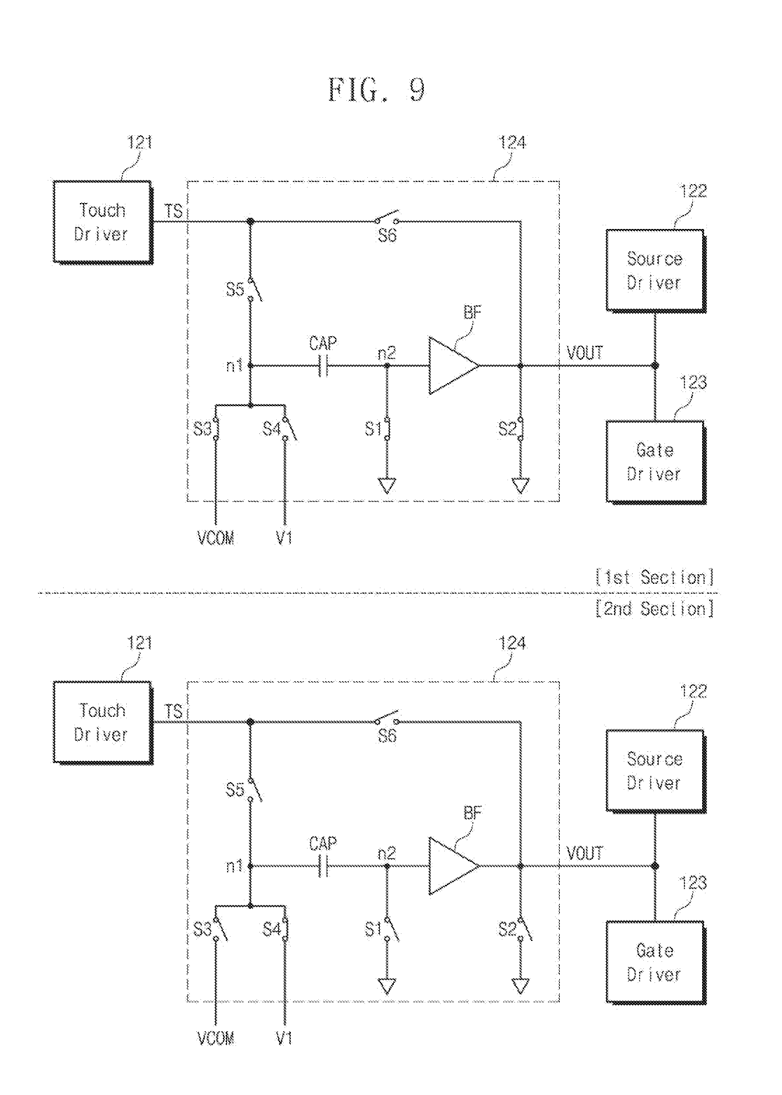

The transition voltage controller 124 may provide the source driver 122 and the gate driver 123 with the output voltage VOUT based on the common voltage VCOM, the first voltage V1, and the touch sensing signal TS. An operation of the transition voltage controller 124 will be more fully described with reference to FIGS. 8 to 9.

FIG. 8 is a timing diagram illustrating an operation of a transition voltage controller of FIG. 7. FIG. 9 is a circuit diagram illustrating switching operations of a transition voltage controller according to the timing diagram of FIG. 8.

Referring to FIGS. 7 to 9, the TDDIC 120 performs a displaying operation during the display period DP. Since the displaying operation that is performed during the display period DP is above described, a detailed description thereof is omitted.

During the display period DP, the first to third switches S1 to S3 of the transition voltage controller 124 are turned on, and the fourth to sixth switches S4 to S6 thereof are turned off. That is, the transition voltage controller 124 is configured as illustrated in a first section of FIG. 9. In this case, a voltage of the first node n1 is the common voltage VCOM, and a voltage of the second node n2 is the ground voltage GND. Accordingly, the capacitor CAP may be charged with the common voltage VCOM.

After the display period DP ends, during the transition period, the fourth switch S4 is turned on, and the first to third, fifth, and sixth switches S1 to S3, S5, and S6 are turned off. That is, the transition voltage controller 124 is configured as illustrated in a second section of FIG. 9. As understood from the first section, the capacitor CAP may be charged with the common voltage VCOM. In this case, as illustrated in the second section, in the case where the fourth switch S4 is turned on and the first to third switches S1 to S3 are turned off, a voltage of the first node n1 may be the first voltage V1. In this case, a voltage of the second node n2 may have a voltage level of (V1−VCOM) by the capacitor CAP. For example, in the case where the common voltage VCOM is a negative voltage of about −1.3 V and the first voltage V1 is the ground voltage GND, the second node n2 of the second section of FIG. 9 may have a voltage level of about 1.3 V.

In other words, the output voltage VOUT of the transition voltage controller 124 may be the ground voltage GND during the display period, and the output voltage VOUT of the transition voltage controller 124 may increase by a predetermined level (i.e., corresponding to a difference between the first voltage V1 and the common voltage VCOM) during the transition period.

The buffer BF may buffer a voltage of the second node n2 and may provide the source driver 122 and the gate driver 123 with the buffered voltage as the output voltage VOUT. The source driver 122 may control voltages of the data lines DL based on the output voltage VOUT, and the gate driver 123 may control voltages of the gate lines GL based on the output voltage VOUT. That is, on the basis of the output voltage VOUT increasing by a predetermined level, the source driver 122 and the gate driver 123 may increase voltages of the data lines DL and the voltages of the gate lines GL by the predetermined level.

For example, the source driver 122 may be configured to provide a data signal to each data line DL during the display period and to provide the output voltage VOUT to each data line DL during the transition period and the touch period. Although not illustrated in FIG. 9, the source driver 122 may include a separate switching circuit or multiplexer for providing the output voltage VOUT to each data line DL in the transition period.

For example, the gate driver 123 may provide each gate line GL with a gate signal for turning on the transistors TR (refer to FIG. 2) of the pixels PIX during the display period. The gate driver 123 may include a separate voltage generator (not illustrated) that increases, by a predetermined level, voltages of the gate lines GL based on the output voltage VOUT during the transition period and the touch period.

After the transition period ends (i.e., after a voltage of each touch sensing line TSL is settled to the first voltage V1), the fifth switch S5 is turned on, and the fourth switch S4 is turned off. As the fifth switch S5 is turned on and the fourth switch S4 is turned off, the touch sensing signal TS from the touch driver 121 is provided to the first node n1. A voltage level of the first node n1 may be toggled by the touch sensing signal TS. As the voltage level of the first node n1 is toggled, a voltage level of the second node n2 may be toggled, and a voltage of the second node n2 may be provided as the output voltage VOUT through the buffer BF. Accordingly, during the touch period TP, the touch sensing signal TS may be provided to the source driver 122 and the gate driver 123 as the output voltage VOUT. In this case, the touch sensing signal provided as the output voltage VOUT is higher than the touch sensing signal TS provided from the touch driver 121 by a difference between the common voltage VCOM and the first voltage V1. As illustrated in FIG. 8, during the touch period TP, the source driver 122 may provide each data line DL with a touch sensing signal of a higher level than that of the second voltage V2, and the gate driver 123 may provide each gate line DL with a touch sensing signal of a higher level than that of the third voltage V3.

After the touch period TP ends, the fourth switch S4 may be turned on, and the fifth switch S5 may be turned off. This may be a switching operation for preventing the touch sensing signal TS from being output as the output voltage VOUT when the touch period TS ends.

Afterwards, during the transition period from the touch period TP to the display period DP in FIG. 8, the fourth switch S4 may be turned off, and the third switch S3 may be turned on. Accordingly, a voltage level of the first node n1 may correspond to a level of the common voltage VCOM. In this case, a voltage charged in the capacitor CAP may correspond to the common voltage VCOM as described above. As the third switch S3 is turned on, a voltage of the second node n2 may decrease to the ground voltage GND. The source driver 122 may lower voltages of the data lines DL to the ground voltage GND based on the output voltage VOUT corresponding to the ground voltage GND, and the gate driver 123 may lower voltages of the gate lines GL to the gate voltage GSL based on the output voltage VOUT corresponding to the ground voltage GND. That is, during the transition period from the touch period TP to the display period DP, a voltage of each touch sensing line TSL may be quickly settled to the common voltage VCOM by lowering voltages of the data lines DL and the gate lines GL as well as voltages of the touch sensing lines TSL.

In the display period DP following the transition period, the first and second switches S1 and S2 may be turned on. Accordingly, a voltage of the second node n2 and the output voltage VOUT may be reset to the ground voltage GND.

In example embodiments, the sixth transistor S6 may remain at a turn-off state during an operation of the TDDIC 120 according to an example embodiment of the inventive concept. In example embodiments, the sixth switch S6 may be a switch for a typical operation of the TDDIC 120, that is, an operation described with reference to FIG. 3. For example, in the case where there is no need to control voltages of the data lines DL and the gate lines GL during the transition period, the sixth switch S6 may be turned on. In this case, as illustrated in FIG. 3, voltages of the data lines DL and the gate lines GL may not increase in the transition period.

Although not illustrated in FIG. 9, in the transition period from the touch period TP to the display period DP, the first and second switches S1 and S2 may be turned on. That is, in the transition period from the touch period TP to the display period DP, a voltage of the second node n2 and the output voltage VOUT may be reset to the ground voltage GND.

As described above, during the transition period from the display period to the transition period, the TDDIC 120 according to an example embodiment of the inventive concept may increase, by a predetermined level, voltages of the data lines DL and the gate lines GL as well as voltages of the touch sensing lines TSL. Also, during the transition period from the touch period TP to the display period DP, the TDDIC 120 may decrease, by a predetermined level, voltages of the data lines DL and the gate lines GL as well as voltages of the touch sensing lines TSL. As such, an influence of parasitic capacitances in the touch display panel 110 may be removed. Accordingly, a settling speed at which the touch sensing line TSL is increased to the first voltage or decreased to the common voltage VCOM may be improved. This means that the TDDIC 120 with improved performance is provided.

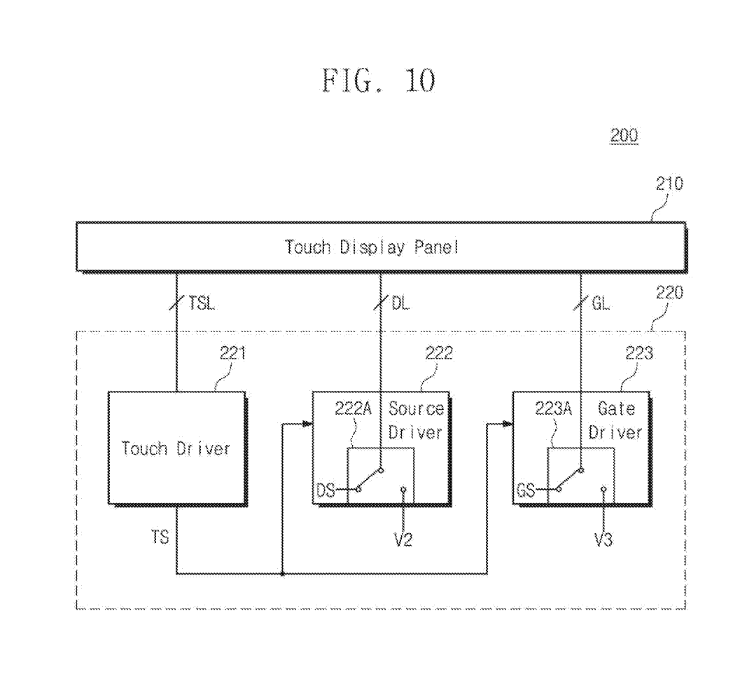

FIG. 10 is a block diagram illustrating another example of a TDDIC for implementing an operation described with reference to FIGS. 4 and 5. Components that are unnecessary to describe a technical feature of the inventive concept are omitted for a brief description.

Referring to FIG. 10, a display device 200 may include a touch display panel 210 and a TDDIC 220. The TDDIC 220 may be connected with the touch display panel 210 through the gate lines GL, the data lines DL, and the touch sensing lines TSL.

The TDDIC 220 may include a touch driver 221, a source driver 222, and a gate driver 223. Since the touch driver 221, the source driver 222, and the gate driver 223 are above described, a detailed description thereof is omitted.

The source driver 222 and the gate driver 223 may include a switching circuit 222A and a switching circuit 223A, respectively. The switching circuit 222A and the switching circuit 223A may be configured to provide the second voltage V2 and the third voltage V3 to each data line DL and each gate line GL during the transition period, respectively.

For example, the switching circuit 222A of the source driver 222 may provide a data signal DS to each data line DL during the display period. In example embodiments, the data signal DS may indicate a signal that the source driver 222 generates based on image data provided from an external device.

During the transition period from the display period to the touch period, the switching circuit 222A may perform a switching operation such that the second voltage V2 is supplied to each data line DL. In an example embodiment, a level of the second voltage V2 may correspond to a level of a voltage generated from a separate voltage generator (not illustrated). The second voltage V2, as described above, may be a voltage higher by a predetermined level (i.e., a difference between the common voltage VCOM and the first voltage V1) than the ground voltage GND. That is, a voltage of each data line DL may increase to the second voltage V2 by an operation of the switching circuit 222A. During the touch period TP, the source driver 222 may provide the touch sensing signal TS, which is provided from the touch driver 221, to each data line DL having a level of the second voltage V2.

Likewise, the gate driver 223 may provide the gate signal GS to each gate line GL during the display period DP. In example embodiments, the gate signal GS may be a switching signal or a clock signal that is synchronized with a control signal (e.g., a horizontal synchronization signal).

During the transition period from the display period to the touch period, the switching circuit 223A may perform a switching operation such that the third voltage V3 is supplied to each gate line GL. In example embodiments, a level of the third voltage V3 may correspond to a level of a voltage generated from a separate voltage generator (not illustrated). The third voltage V3, as described above, may be a voltage higher by a predetermined level (i.e., a difference between the common voltage VCOM and the first voltage V1) than the gate voltage VGL. That is, a voltage of each gate line GL may increase to the third voltage V3 by an operation of the switching circuit 223A. During the touch period TP, the gate driver 223 may provide the touch sensing signal TS, which is provided from the touch driver 221, to each gate line GL having a level of the third voltage V3.

In example embodiments, an operation of the transition period from the touch period to the display period may be similar to that described above. For example, the switching circuit 222A of the source driver 222 may perform a switching operation such that the data signal DS is provided to each data line DL. In this case, a voltage level of the data signal DS may correspond to a level of the ground voltage GND. Likewise, the switching circuit 223A of the gate driver 223 may perform a switching operation such that the gate signal GS is provided to each gate line GL. In this case, a voltage level of the gate signal GS may correspond to a level of the gate voltage VGL.

As described above, during the transition period, the switching circuit 222A of the source driver 222 may provide the second voltage V2 from a separate voltage generator (not illustrated) to each data line DL, and the switching circuit 223A of the gate driver 223 may provide the third voltage V3 from a separate voltage generator (not illustrated) to each gate line GL. As described above, during the transition period, as voltages of the data lines DL and the gate lines GL increase by a predetermined level together with each other, a settling speed at which the touch sensing line TSL is increased to the first voltage or decreased to the common voltage VCOM may become faster. This makes the following touch operation time point earlier.

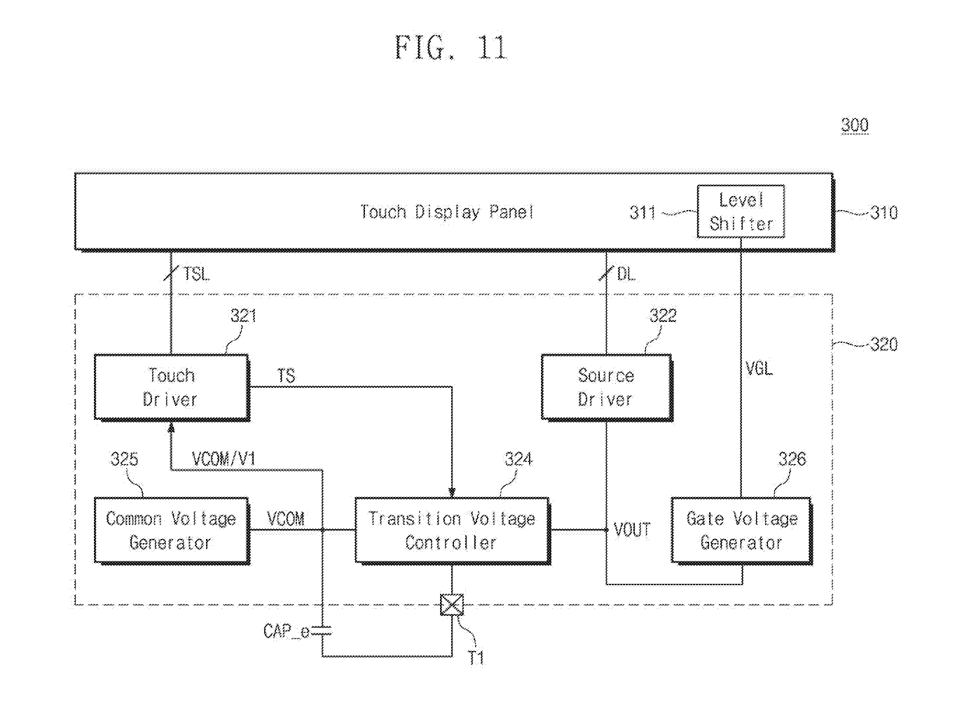

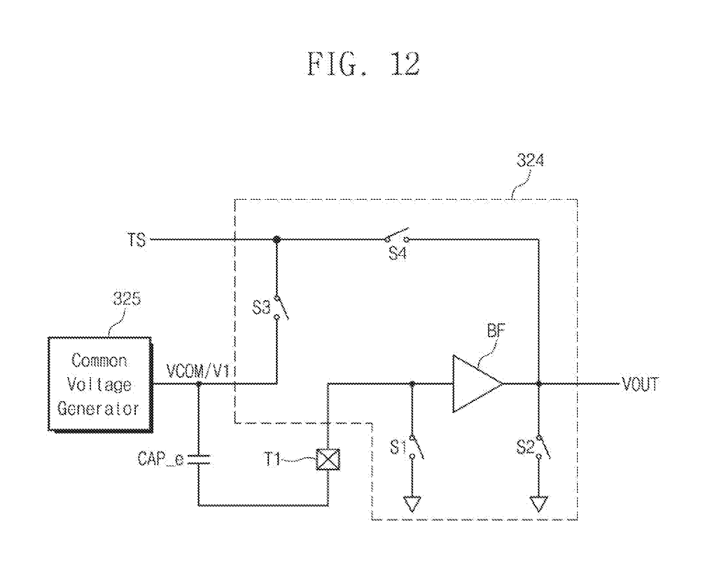

FIG. 11 is a block diagram illustrating another example of a TDDIC for implementing an operation described with reference to FIGS. 4 and 5. FIG. 12 is an exemplary block diagram of a transition voltage controller using an external capacitor. Descriptions of components that have already been are omitted for a brief description.

Referring to FIGS. 11 and 12, a display device 300 may include a touch display panel 310 and a TDDIC 320. The TDDIC 320 includes a touch driver 321, a source driver 322, a transition voltage controller 324, a common voltage generator 325, and a gate voltage generator 326. For a brief description, a detailed description of the above-described components is omitted.

Unlike the above-described TDDIC, the TDDIC 320 of FIG. 11 may omit a separate gate driver. For example, the TDDIC 320 may include the gate voltage generator 326, and the gate voltage generator 326 may generate the gate voltage VGL and may provide the gate voltage VGL to a level shifter 311 of the touch display panel 310. The level shifter 311 may be connected with a plurality of pixels (not illustrated) through a plurality of gate lines (not illustrated). The level shifter 311 may provide a gate signal to each gate line in response to a separate control signal (e.g., a horizontal synchronization signal or a gate control signal).

In example embodiments, as illustrated in FIG. 11, the common voltage generator 325 may be connected with an external capacitor CAP_e. The external capacitor CAP_e may be used as a stabilization capacitor for stabilizing the common voltage VCOM. In example embodiments, the transition voltage controller 324 may use the external capacitor CAP_e connected with the common voltage generator 325 as the capacitor CAP described with reference to FIG. 7. A configuration of the transition voltage controller 324 that uses the external capacitor CAP_e will be more fully described with reference to FIG. 12.

As illustrated in FIG. 12, the transition voltage controller 324 may include first to fourth switches S1 to S4 and a buffer BF. The first switch S1 is configured to connect a first node T1 and a ground voltage. The second switch S2 is configured to connect a terminal of the output voltage VOUT and a terminal of the ground voltage GND. The third switch S3 is configured to connect a first end of the external capacitor CAP_e and a terminal for receiving the touch sensing signal TS. The fourth switch S4 is configured to connect the terminal for receiving the touch sensing signal TS and the terminal of the output voltage VOUT. The buffer BF may buffer a voltage of the first terminal T1 and may provide the buffered voltage as the output voltage VOUT.

The first end of the external capacitor CAP_e may be connected with the common voltage generator 325 to receive the common voltage VCOM from the common voltage generator 325. A second end of the external capacitor CAP_e may be connected with the first terminal T1.

The common voltage generator 325 may apply the common voltage VCOM to the first end of the external capacitor CAP_e in the display period DP. That is, the common voltage generator 325 may use the external capacitor CAP_e as a stabilization capacitor.

After the display period DP ends, the common voltage generator 325 may provide the first voltage V1 to the first end of the external capacitor CAP_e. That is, the common voltage generator 325 may be configured to perform operations of the third and fourth switches S3 and S4 of FIG. 7.

In example embodiments, the first, second, third, and fourth switches S1, S2, S3, and S4 of FIG. 12 may perform switching operations that are similar to those of the first, second, fifth, and sixth switches S1, S2, S5, and S6 of FIG. 7.

As described above, the transition voltage controller 324 may generate the output voltage VOUT for controlling voltages of the gate lines GL and the data lines DL in the transition period, by using the external capacitor CAP_e connected with the common voltage generator 325.

In example embodiment, although not illustrated in FIG. 12, the common voltage generator 325 may be configured to switch the common voltage VCOM, the first voltage V1, and the touch sensing signal TS. That is, the common voltage generator 325 may be configured to perform operations of the third, fourth, and fifth switches S3, S4, and S5 of FIG. 7.

A configuration of function blocks and circuits described with reference to FIGS. 6 to 12 is exemplary, and example embodiments of the inventive concept are not limited thereto. A circuit configuration for implementing an example embodiment of the inventive concept may be various modified or changed.

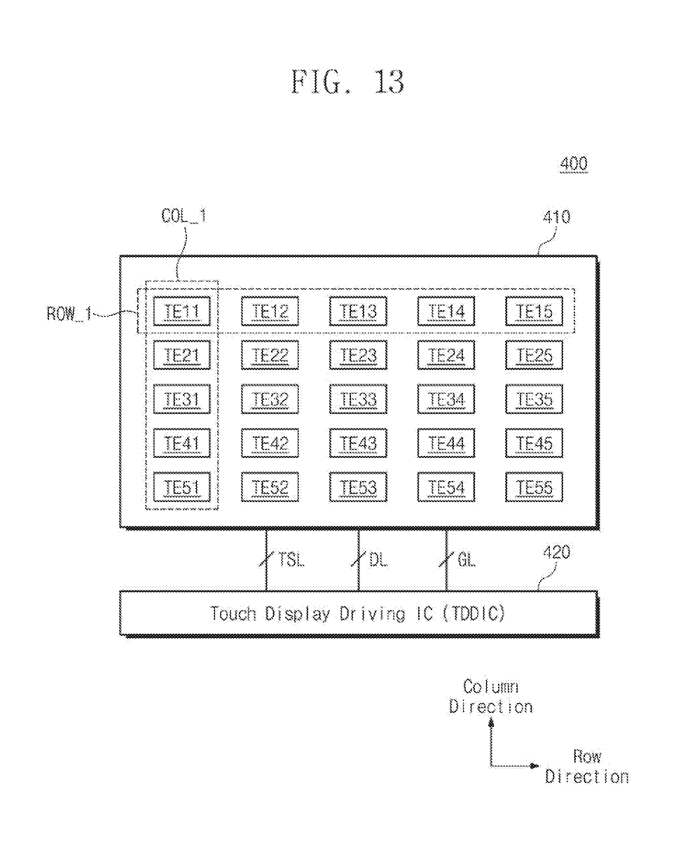

FIG. 13 is a drawing illustrating arrangement of a plurality of touch electrodes included in a touch display panel of FIG. 1. Referring to FIG. 13, a display device 400 may include a touch display panel 410 and a TDDIC 420. The touch display panel 410 may include a plurality of touch electrodes TE11 to TE55. In example embodiments, for ease of illustration and for convenience of description, the remaining components other than the touch electrodes TE11 to TE55 are not illustrated in FIG. 13. However, as described above, the touch electrodes TE11 to TE15 may be connected with the TDDIC 420 through different touch sensing lines TSL, respectively. Also, the touch display panel 410 may include a plurality of pixels (not illustrated), which are connected with the TDDIC 420 through the gate lines GL and the data lines DL. One touch electrode may correspond to at least one pixel. That is, one touch electrode may be used as a common electrode of at least one corresponding pixel. In some example embodiments, one touch electrode may correspond to a plurality of pixels such that the one touch electrode may be used as a common electrode of the plurality of pixels with which the one touch electrode is associated.

As described above, as the TDDIC 420 repeatedly performs the display period and the touch period, the TDDIC 420 may display image information and may sense a touch of the user. In this case, a touch scan operation may be performed on some of the touch electrodes TE11 to TE55 in one touch period. For example, in one touch period (i.e., a first touch period), the TDDIC 420 may perform the touch scan operation on touch electrodes TE11, TE21, TE31, TE41, and TE51 arranged in a first column COL_1. That is, in the first touch period, the TDDIC 420 may provide a touch sensing signal to each of touch sensing lines TSL connected with the touch electrodes TE11 to TE51 arranged in the first column COL_1 and may sense a touch of the user based on signal variations of the touch sensing lines TSL.

In this case, the TDDIC 420 may be configured to control data lines DL and gate lines GL that are connected with pixels corresponding to the touch electrodes TE11 to TE51 of the first column COL_1. In a more detail, to perform the touch scan operation on the touch electrodes TE11 to TE51 of the first column COL_1 in the first touch period, the TDDIC 420 may increase voltages of the touch sensing lines TSL connected with the touch electrodes TE11 to TE51 of the first column COL_1 from the common voltage VCOM to the first voltage V1 (refer to FIG. 1). In this case, as described above, the TDDIC 420 may increase voltages of the data lines DL and the gate lines GL that are connected with the pixels corresponding to the touch electrodes TE11 to TE51 of the first column COL_1 by a predetermined level.

Alternatively, the TDDIC 420 may perform the touch scan operation on touch electrodes TE11, TE12, TE13, TE14, and TE15 of a first row ROW_1. As described above, the TDDIC 420 may be configured to control data lines DL and gate lines GL that are connected with pixels corresponding to the touch electrodes TE11 to TE15 of the first row ROW_1.

As such, the TDDIC 420 may be configured to control voltages of some touch sensing lines, some data lines, and some gate lines during the transition period. In this case, some touch sensing lines may indicate touch sensing lines connected with touch electrodes on which the touch scan operation will be performed, and some data lines and some gate lines may indicate lines connected with pixels corresponding to the touch electrodes on which the touch scan operation will be performed.

Although not illustrated in FIG. 13, the touch scan operation may be performed for each specific row, for each specific column, or for each specific area, and gate lines and data lines that are controlled during the transition period may be variously changed or modified according to touch electrodes on which the touch scan operation will be performed.

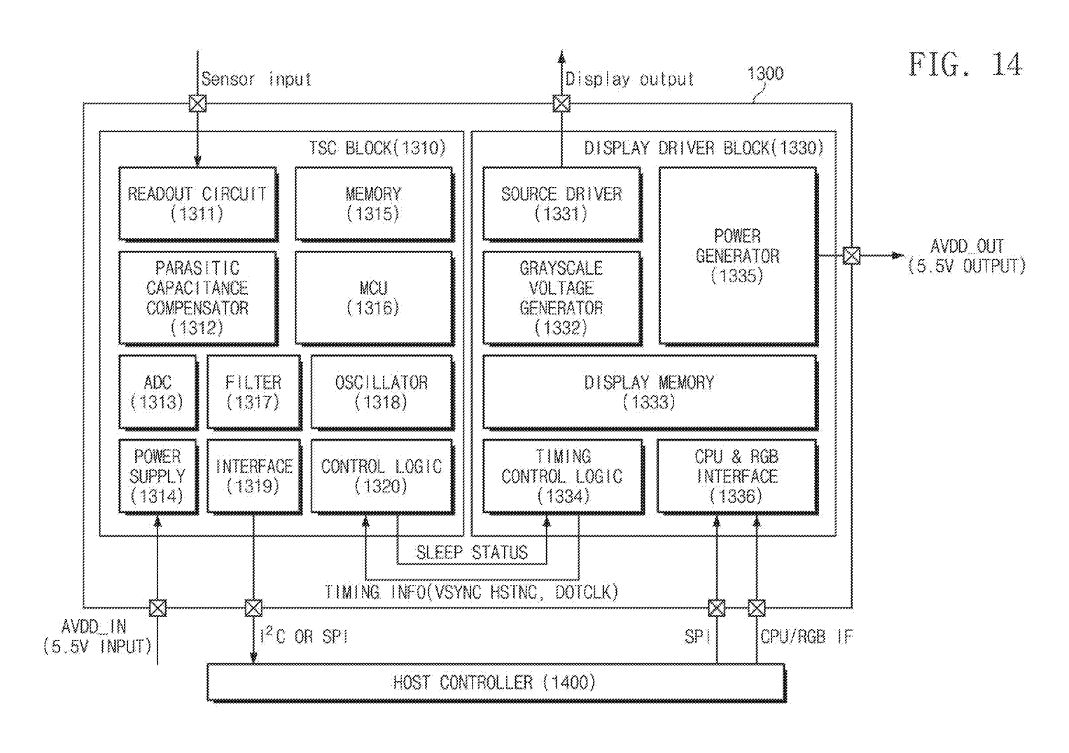

FIG. 14 is a block diagram illustrating an integrated circuit to an example embodiment of the inventive concept. Referring to FIG. 14, an integrated circuit 1300 may include a touch driver block 1310 operating as a touch driver and a display driver block 1330 operating as a source driver (or a gate driver or a display driver). Manufacturing costs may be reduced by integrating the touch driver block 1310 and the display driver block 1330 in one semiconductor chip, one semiconductor die, or one semiconductor package. Influence of noise at a touch screen operation may be reduced by synchronizing a sensing signal of the touch driver block 1310 with a signal generated from the display driver block 1330. In example embodiments, the integrated circuit 1300 may be operated according to example embodiments of this inventive concept.

The touch driver (TSC) block 1310 may include various components for the touch screen operation. For example, the touch driver (TSC) block 1310 may include a readout circuit 1311, a parasitic capacitance compensator 1312, an analog-to-digital converter (ADC) 1313, a power supply 1314, a memory 1315, a micro control unit (MCU) 1316, a filter 1317, an oscillator 1318, an interface 1319, and control logic 1320.

The readout circuit 1311 may generate touch data. The parasitic capacitance compensator 1312 may reduce or compensate for parasitic capacitance components of a sensing unit. The ADC 1313 may convert analog data into a digital signal. The power supply voltage generation part 1314 may generate a power supply voltage, for example, about 4V to about 5V. The filter 1317 may provide digital filtering, and may be, for example, a digital FIR low pass filter. The oscillator 1318 may generate a low-power oscillation signal. The interface 1319 may exchange signals with a host controller 1400, and may be, for example, an SPI or I²C interface in some example embodiments.

The display driver block 1330 may include a source driver 1331, a grayscale voltage generator 1332, a display memory 1333, timing control logic 1334, a power generator 1335, a central processing unit (CPU) and RGB interface (CPU & RGB interface) 1336.

The source driver 1331 may generate grayscale data. The display memory 1333 may store display data. The timing control logic 1334 may generate a control signal (or synchronization signal) for controlling each component of the display driver block 1330. The power generator 1335 may generate one or more power supply voltages. The CPU and RGB interface 1336 may control overall operations of the display driver block 1330 and/or may communicate with the host controller 1400.

The touch driver block 1310 may receive at least a piece of timing information from the display driver block 1330. For example, the control logic 1320 of the touch driver block 1310 may receive various timing information (e.g., VSYCN, HSYCN, and DOTCLK) that are synchronized with a display output signal from the timing control logic 1334 of the display driver block 1330. The control logic 1320 may generate a control signal for controlling a generation time point of touch data by using the received timing information.

In example embodiments, the display driver block 1330 may receive at least a piece of information from the touch driver block 1310. For example, as illustrated in FIG. 14, the display driver block 1330 may receive a status signal (e.g., a sleep status signal) from the touch driver block 1310. The display driver block 1330 may perform an operation corresponding to the sleep status signal received from the touch driver block 1310.

That the touch driver block 1310 is at a sleep state indicates that a touch operation is not performed during a uniform period. In this case, the display driver block 1330 may interrupt an operation of providing timing information to the touch driver block 1310, thereby making it possible to efficiently use power of a device (e.g., a mobile device) including the integrated circuit 1300.

In example embodiments, the display driver block 1330 may perform an operation described with reference to FIGS. 1 to 13, that is, an operation of increasing or decreasing voltages of data and gate lines by a predetermined level in the transition period. Although not illustrated in FIG. 14, the integrated circuit 1300 may further include a transition voltage controller that performs the operation described with reference to FIGS. 1 to 13. The transition voltage controller may be included in the touch driver block 1310 or the display driver block 1330. Additionally or alternatively, the transition voltage controller may be provided in a separate block of the integrated circuit 1300

As illustrated in FIG. 14, each of the touch driver block 1310 and the display driver block 1330 includes a circuit block that generates power, a memory that stores data, and control unit that controls functions of the blocks. As such, in the case where the touch driver block 1310 and the display driver block 1330 are integrated in one semiconductor chip, the memory, the circuit block, the control logic, etc. may be implemented to be shared by the touch driver block 1330 and the display driver block 1330.

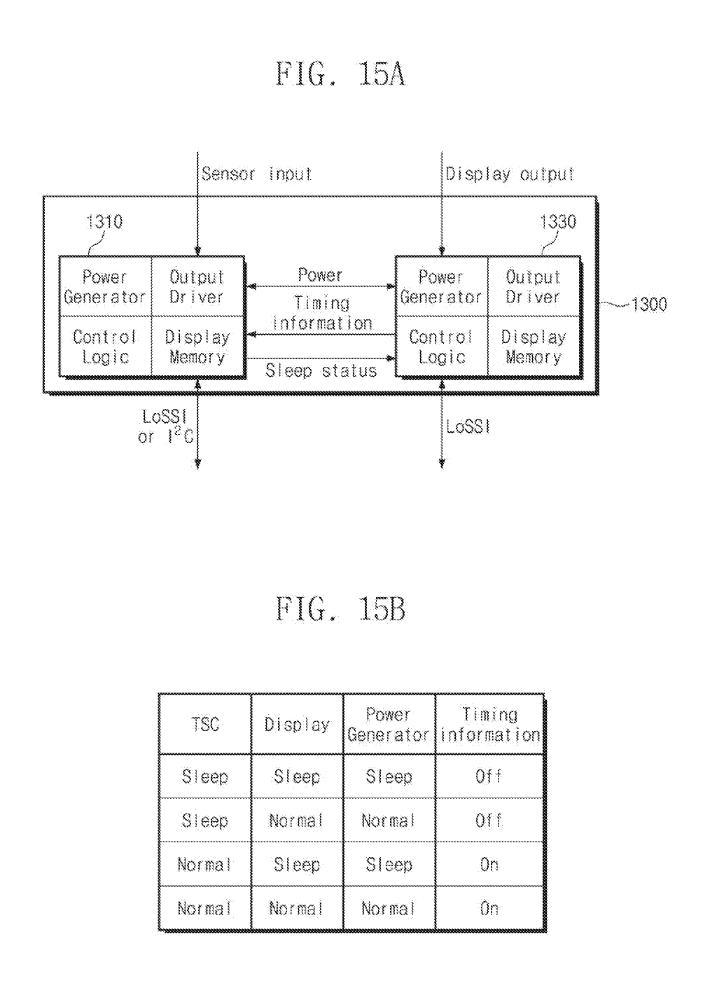

FIGS. 15A and 15B are drawings illustrating timing between a touch driver block and a display driver block of FIG. 14. Referring to FIGS. 14, 15A, and 15B, as illustrated in FIG. 14, the integrated circuit 1300 for driving a display device may include the touch driver block 1310 and the display driver block 1330. The touch driver block 1310 and the display driver block 1330 may exchange timing information and status information, etc. with each other as described above. Also, the touch driver block 1310 may provide or receive a power supply voltage to or from the display driver block 1330 and vice versa.

For convenience of description and for ease of illustration, the simplified touch driver block 1310 and the simplified display driver block 1330 are illustrated in FIG. 14, but the touch driver block 1310 may include an analog front end (AFE) that may include a voltage readout circuit, an amplification circuit, an integration circuit, an ADC, etc.

The touch driver block 1310 of the display device according to an example embodiment of the inventive concept may provide the sleep status information to the display driver block 1330. In example embodiments, also, an operation in which a power supply voltage used in the touch driver block 1310 is provided from the display driver block 1330 is as follows.

As illustrated in FIG. 15B, in the case where a touch input does not operate while a screen is turned off (in the case where the blocks 1310 and 1330 all are at a sleep state), the display driver block 1330 may block the provision of the power supply voltage or timing information to the touch driver block 1310. In this case, the display driver block 1330 may maintain only a status of a register therein with a previous state. Accordingly, power consumption may be minimized.

In the case where a touch input is deactivated and only a display is activated (in the case where TSC: sleep and display: normal), the display driver block 1330 may generate a power supply voltage for one's own consumption, but the display driver block 1330 may not provide the power supply voltage to the touch driver block 1310 because the touch driver block 1310 does not consume power. Also, the display driver block 1330 may not provide the timing information to the touch driver block 1310.

In the case where the touch input is activated and the display is inactivated (in the case where TSC: normal and display: sleep), since the touch input is activated, whether a touch operation is performed is determined periodically. In this case, the display driver block 1330 operates in a low-power mode and maintains an inactive state. However, to determine whether the touch operation is performed, the display driver block 1330 may generate the timing information and a power supply voltage to be used in the touch driver block 1310 and may provide the timing information and the power supply voltage to the touch driver block 1310.

Meanwhile, as a normal case, in the case where both the touch input and the display are activated (in the case where TSC: normal and display: normal), the display driver block 1330 may generate timing information and a power supply voltage and may provide the timing information and the power supply voltage to the touch driver block 1310.

It may be understood from the above-described cases with reference to FIG. 15B that a power generator of the display driver block generates a power supply voltage when at least one of the touch driver block 1310 and the display driver block 1330 is activated. Also, control logic of the display driver block 1330 may generate timing information only when the touch driver block operates and may provide the timing information to the touch driver block 1310.

According to an example embodiment of the inventive concept, when a display period and a touch period are switched, as a time used to increase a voltage of a touch sensing line from a common voltage to a ground voltage and/or a time used to decrease a voltage of the touch sensing line from the ground voltage to the common voltage is reduced, a touch display driving integrated circuit with improved performance and an operating method thereof may be provided.

While the inventive concept has been described with reference to exemplary embodiments, it will be apparent to those skilled in the art that various changes and modifications may be made without departing from the spirit and scope of the inventive concept. Therefore, it should be understood that the above example embodiments are not limiting, but illustrative.

1. An operating method of a touch display driving integrated circuit that is configured to be connected with a touch display panel through touch sensing lines and data lines, the method comprising:
applying a common voltage to each touch sensing line;
increasing voltages of the touch sensing lines and the data lines by a predetermined level;
providing a first touch sensing signal to each touch sensing line; and
sensing a touch of a user based on signal variations of the touch sensing lines.

2. The method of claim 1, wherein the increasing of the voltages comprises:
increasing a voltage of each touch sensing line from the common voltage to a first voltage; and
increasing a voltage of each data line from a ground voltage to a second voltage.

3. The method of claim 2, wherein a difference between the common voltage and the first voltage is the same as a difference between the ground voltage and the second voltage.

4. The method of claim 2, wherein the common voltage is a negative voltage and the first voltage is the ground voltage.

5. The method of claim 2, wherein the providing of the first touch sensing signal to each touch sensing line comprises:
providing each data line with a second touch sensing signal of which a voltage level is higher by the predetermined level than that of the first touch sensing signal.

6. The method of claim 1, further comprising:
providing a data signal to each data line while the common voltage is applied to each touch sensing line.

7. The method of claim 1, further comprising:
decreasing voltages of the touch sensing lines and the data lines by the predetermined level after completing determining whether the touch of the user is made, based on the signal variations of the touch sensing lines.

8. The method of claim 1, wherein the touch display driving integrated circuit is configured to be connected with the touch display panel through the touch sensing lines, the data lines, and gate lines, the method further comprising:
providing a gate voltage to the touch display panel,
wherein the increasing of the voltages comprises:
increasing voltages of the gate lines by the predetermined level.

9. The method of claim 1, wherein the touch display driving integrated circuit is connected with touch electrodes of the touch display panel through the touch sensing lines and is connected with pixels of the touch display panel through the data lines.

10. The method of claim 9, wherein the touch electrodes are used as common electrodes of the pixels while the common voltage is applied to each touch electrode.

11. A touch display driving integrated circuit comprising:
a touch driver connected to touch electrodes through touch sensing lines to provide a common voltage to each touch sensing line during a display period and to provide a first touch sensing signal to each touch sensing line during a touch period;
a transition voltage controller configured to output a first output voltage during the display period and to output a second output voltage higher by a predetermined level than the first output voltage during a transition period from the display period to the touch period; and
a source driver connected with pixels through data lines to provide a data signal to each data line during the display period and to provide the second output voltage to each data line during the transition period.

12. The touch display driving integrated circuit of claim 11, wherein the touch driver is configured to increase a voltage of each touch sensing line from the common voltage to a first voltage during the transition period, and
wherein the source driver is configured to increase a voltage of each data line from a ground voltage to a second voltage based on the second output voltage during the transition period.

13. The touch display driving integrated circuit of claim 12, further comprising:
a gate driver configured to generate a gate voltage based on the first and second output voltages.

14. The touch display driving integrated circuit of claim 11, wherein the source driver is configured to provide a second touch sensing signal, of which a voltage level is higher by the predetermined level than that of the first touch sensing signal, to each data line in the touch period.

15. The touch display driving integrated circuit of claim 11, wherein the transition voltage controller comprises:
a first switch configured to connect a first node and a ground voltage;
a second switch configured to connect a node of the output voltage and the ground voltage;
a third switch configured to connect a second node and the common voltage;
a fourth switch configured to connect the second node and the first voltage;
a fifth switch configured to connect the second node and a node for receiving the touch sensing signal from the touch driver;
a capacitor connected between the first node and the second node; and
a buffer connected between the first node and the node of the output voltage.

16. The touch display driving integrated circuit of claim 15, wherein during the display period, the first to third switches are in a turn-on state and the fourth and fifth switches are in a turn-off state,
wherein during the transition period, the fourth switch is in a turn-on state and the first, second, third, and fifth switches are in a turn-off state, and
wherein during the touch period, the fifth switch is in a turn-on state and the first, second, third, and fourth switches are in a turn-off state.

17. The touch display driving integrated circuit of claim 11, further comprising:
a common voltage generator configured to generate the common voltage; and
a stabilization capacitor connected with the common voltage generator.

18. A touch display device comprising:
a touch display panel including a touch electrode and a pixel; and
a touch display driving integrated circuit configured to control the touch display panel,
wherein the touch display driving integrated circuit comprises:
a touch driver connected with the touch electrode through a touch sensing line to apply a common voltage to the touch sensing line during a display period and to provide a first touch sensing signal to the touch sensing line during a touch period;
a transition voltage controller configured to output a first output voltage during the display period and to output a second output voltage higher by a predetermined level than the first output voltage during a transition period from the display period to the touch period; and
a source driver connected with the pixel through a data line to provide a data signal to the data line during the display period and to provide the second output voltage to the data line during the transition period.

19. The touch display device of claim 18, wherein the touch driver is configured to increase a voltage of the touch sensing line from the common voltage to a first voltage during the transition period.

20. The touch display device of claim 18, wherein during the touch period, the transition voltage controller outputs a second touch sensing signal of which a voltage level is higher by the predetermined level than that of the first touch sensing signal and the source driver provides the second touch sensing signal to the data line.

21-26. (canceled)
